(19) United States
(12) Patent Application Publication
(10) Pub. No.: US 2008/0089789 A1
(43) Pub. Date: Apr. 17, 2008

(54) AIRFOILS FOR USE WITH TURBINE ASSEMBLIES AND METHODS OF ASSEMBLING THE SAME

(76) Inventors: Thomas Joseph Farineau, Schoharie, NY (US); Eloy Vincent Emeterio, Amsterdam, NY (US); Robert Edward Deallenbach, Schenectady, NY (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(21) Appl. No.: 11/550,273

(22) Filed: Oct. 17, 2006

(51) Int. Cl. B64C 11/04

(52) U.S. Cl. 416/204 R

(57) ABSTRACT

A method for assembling a turbine assembly is provided. The method includes providing at least two buckets that each include an axial entry dovetail, a tip and an airfoil extending therebetween. The method also includes coupling the at least two buckets to a rotor wheel by inserting the axial entry dovetail into at least one complementary-configured mating dovetail slot defined in the rotor wheel, and coupling a bucket cover to the tip of the at least two buckets such that the bucket cover substantially circumscribes the rotor wheel in a continuous band.

### BACKGROUND OF THE INVENTION

This invention relates generally to the use of turbine assemblies, and more particularly, to rotating airfoils used with turbine assemblies.

Airfoils, or buckets, used with steam turbines are subjected to harmonic stimulus from numerous sources during operation of the steam turbines. Harmonic stimulus frequencies coinciding with a bucket's natural frequency may cause significant resonance in the bucket. Over time, this resonance may cause high cycle fatigue in the bucket and may contribute to reducing the useful service life of the bucket.

At least some known bucket and associated bucket cover designs include tangential entry dovetail buckets and segmented tip shrouds. Tangential entry dovetail buckets are assembled to the wheel through an assembly gate and then packed circumferentially about the wheel circumference. Known segmented tip shrouds include four or more discrete bands connecting the tips of buckets coupled together about the periphery of the rotor assembly. During operation however, such designs may engender numerous vibratory modes, i.e., natural frequencies, within the per revolution operating frequency range. Moreover, relatively low natural frequencies may enhance the susceptibility of such bucket and bucket cover designs to significant per rev resonance, which may compromise the mechanical integrity of the bucket and/or bucket cover. Increasingly, such designs may be unable to withstand increased turbine output.

Other known bucket and cover designs include axial entry dovetail buckets having integral shrouds. In such designs, circumferentially adjacent shrouds lock-up with speed forming a continuously coupled structure. Such designs may also engender vibratory modes within the per revolution operating frequency range and may be unable to withstand increased turbine output. Additionally, these designs may not be well suited for variable speed applications where the amount of lock-up, or coupling, varies as a function of speed. Fabricating the axial entry buckets with integral shroud can be expensive and fixturing limitations have primarily limited their use to the last stage of a turbine.

### BRIEF DESCRIPTION OF THE INVENTION

In one embodiment, a method for assembling a turbine assembly is provided. The method includes providing at least two buckets that each include an axial entry dovetail, a tip and an airfoil extending therebetween. The method also includes coupling the at least two buckets to a rotor wheel by inserting the axial entry dovetail into at least one complementary-configured mating dovetail slot defined in the rotor wheel, and coupling a bucket cover to the tip of the at least two buckets such that the bucket cover substantially circumscribes the rotor wheel in a continuous band.

In another exemplary embodiment, a turbine assembly is provided. The assembly includes a rotor wheel including at least one dovetail slot defined therein and at least two buckets that each includes an axial-entry dovetail, a tip and an airfoil extending therebetween. Each of the at least two buckets is coupled to the rotor wheel via the dovetail slot. The assembly also includes a bucket cover coupled to the tip of the at least two buckets such that the bucket cover substantially circumscribes the rotor wheel.

In yet another exemplary embodiment, a steam turbine assembly is provided. The assembly includes a rotor wheel including at least one dovetail slot defined therein, and at least two buckets each including an axial entry dovetail, a tip and an airfoil extending therebetween. Each of the at least two buckets is coupled to the rotor wheel and the dovetail is at least one of a straight entry dovetail, a slanted entry dovetail and a slanted entry dovetail. The assembly also includes a bucket cover coupled to the tip of the at least two buckets such that the bucket cover substantially circumscribes the rotor wheel and increases the natural frequency of the at least two buckets.

### BRIEF DESCRIPTION OF THE DRAWINGS

FIG. 1 is a cross-sectional schematic view of a portion of an exemplary steam turbine;

FIG. 2 is a perspective view of an axially-mounted bucket that may be used with the steam turbine shown in FIG. 1; and

FIG. 3 is an enlarged perspective view of an exemplary bucket cover.

### DETAILED DESCRIPTION OF THE INVENTION

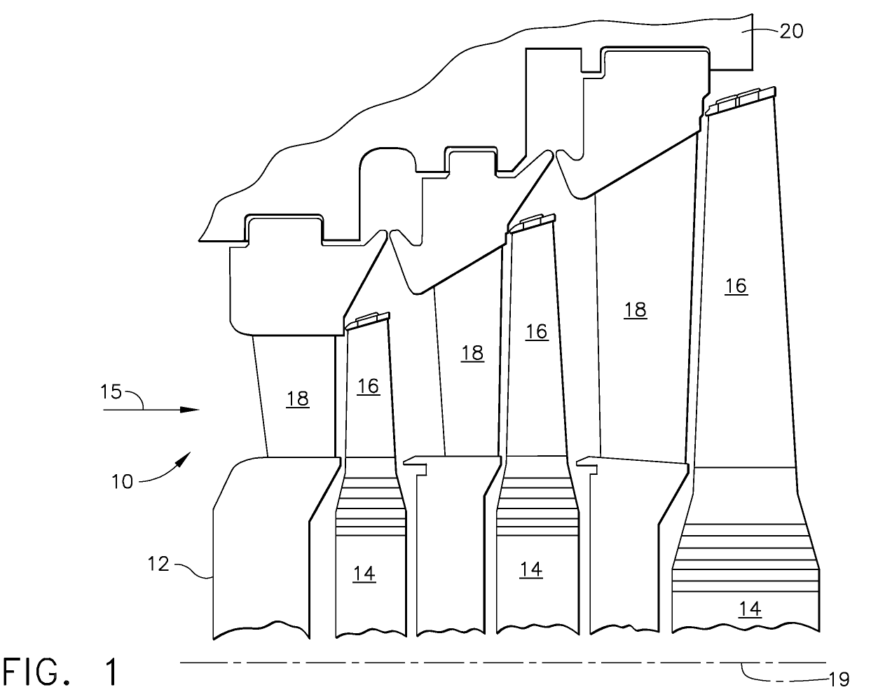

FIG. 1 is a partial cross-sectional schematic view of a portion of an exemplary steam turbine 10 including an impulse rotor assembly 12 and a plurality of axially spaced rotor wheels 14 used to couple axial buckets 16 to rotor assembly 12. A series of nozzles 18 extend in rows between adjacent rows of buckets 16. Nozzles 18 cooperate with buckets 16 to form a stage and to define a portion of a steam flow path, or a hot gas flow path, indicated by the arrow 15 that extends through turbine 10.

In operation, high pressure fluid enters an inlet end (not shown) of turbine 10 and moves through turbine 10 generally parallel to an axis 19 of rotor assembly 12. The steam strikes a row of nozzles 18 and is directed downstream against buckets 16. The hot gas then passes through the remaining stages, thus forcing buckets 16 and rotor assembly 12 to rotate. The term “axial” as used herein is intended to be in a direction generally parallel to axis 19.

FIG. 2 is a perspective view of an exemplary bucket 16 that may be used with steam turbine 10 (shown in FIG. 1). Bucket 16 includes a straight entry axial-entry dovetail 22, a base 28, an airfoil 30 and a tip 34. Dovetail 22 includes a radially inner end 24 and a radially outer end 26. It should be appreciated that although axial dovetail 22 is described as being a straight entry type dovetail, dovetail 22 may be any type of axial dovetail, such as, but not limited to, a slanted or curved entry dovetail, that enables buckets 16 to function as described herein. Further, it should be appreciated that the dovetail cross-sectional area may be any cross-sectional area, such as, but not limited to, square-shaped, rectangular, and/or triangular, that enables buckets 16 to function as described herein. Base 28 extends between outer end 26 and airfoil 30. Airfoil 30 extends from a root 32 adjacent to base 28 to bucket tip 34. In the exemplary embodiment, bucket tip 34 includes a tip platform 36 and tenons 38 and 40. Tip platform 36 is oriented generally parallel to base 28, and tenons 38 and 40 extend substantially perpendicularly away from tip platform 36. It should be appreciated that bucket airfoil 30 may extend at any angle away from base 28 and tenons 38 and 40 may extend at any angle away from tip platform 36 that enables buckets 16 to function as described herein.

A maximum load for each bucket 16 is partially determined by its natural frequency. Thus, raising the natural frequency of each bucket 16 generally increases the maximum tolerable load for that bucket 16. Continuously coupling bucket tips 34 together facilitates increasing the natural frequency of each bucket 16. Consequently, in the exemplary embodiment, and as described in more detail below, a continuous bucket cover (not shown in FIG. 2) circumscribes rotor assembly 12 and is coupled to each bucket tip 34 to facilitate increasing the natural frequency of each bucket 16. Moreover, a continuous bucket cover decreases the modes of vibration of each bucket 16.

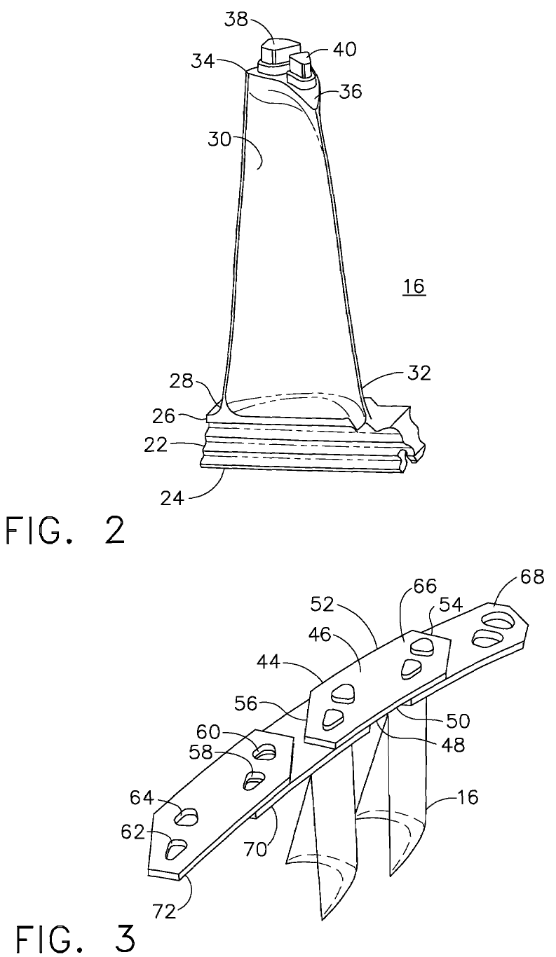

FIG. 3 is an enlarged perspective view of an exemplary chain link bucket cover 42 used with buckets 16 and rotor assembly 12. More specifically, bucket cover 42 includes a plurality of links 44 coupled together to form a chain link type bucket cover 42. In the exemplary embodiment, each link 44 is a plate that includes a radially outer top surface 46, a radially inner bottom surface 48, a first side 50, an opposite second side 52, a first end 54 and an opposite second end 56. Each end 54 and 56 includes a pair of side edges 55 that form an apex 57 and a pair of openings 58 and 60 that extend through cover 42 from top surface 46 to bottom surface 48. Openings 58 and 60 are each sized and shaped to mate with one of complementary-shaped and oriented tenons 38 or 40. Likewise, second end 56 includes a pair of openings 62 and 64 that are shaped and oriented to mate with one of the complementary-configured tenons 38 or 40. In the exemplary embodiment, openings 58 and 60 are identical to openings 62 and 64.

Links 44 are arranged in an alternating overlapping pattern that forms a continuous overlapping chain link bucket cover 42. Generally, links 44 are oriented such that first end 54 of an “over” link 66, 72 overlaps second end 56 of an “under” link 68, 70, and such that the second end 56 of each over link 66, 72 overlaps with the first end 54 of an under link 68, 70. More specifically, in the exemplary embodiment, when fully assembled, the bottom surface 48 of the first end 54 of an over link 66 is positioned substantially flush against the top surface 46 of the second end 56 of an under link 68. Moreover, over link 66 and under link 68 are aligned with respect to each other such that opening 58 of over link 66 aligns with opening 62 of under link 68, and such that opening 60 is aligned with opening 64. Similarly, the bottom surface 48 of second end 56 of over link 66 is positioned substantially flush against the top surface 46 of first end 54 of under link 70. In addition, over link 66 and under link 70 are aligned so that opening 62 of over link 66, aligns with opening 58 of under link 70, and such that opening 64 is aligned with opening 60 of under link 70. When links 42 are aligned, buckets 16 are coupled to bucket cover 42 by inserting tenons 38 and 40 into complementary-configured openings defined by openings 60 and 64, and/or openings 58 and 62. Tenons 38 and 40 are riveted over the “over” links 66 and 72 creating a rigid connection. The “under” links 68 and 70, by comparison, are assembled with a slip fit to allow for expansion. It should be appreciated that although the bucket cover 42 in the exemplary embodiment is an over and under overlapping chain link cover, other various exemplary embodiments may use any other type of continuous bucket cover that enables bucket cover 42 to function as herein described.

Because bucket cover 42 is coupled to each bucket 16, as opposed to extending only over groups of buckets 16, bucket cover 42 continuously circumscribes the periphery of rotor wheel 14 and rotor assembly 12. Continuously coupling the bucket cover 42 to each bucket tip 34 results in a stiffer assembly having higher natural frequency and greater load capability, thus facilitating preventing harmful vibrations and related stresses from developing in buckets 16 during periods of increased turbine output. Moreover, because the cover 42 is not integral with bucket tip 34, bucket 16 is more cost effective. That is, because a shroud isn't required, each bucket 16 is less expensive to manufacture and repair. Furthermore, the exemplary embodiment described herein is easier to assemble, is better suited for variable speed applications than integrally covered axial entry designs, and may be used at all stages of a turbine, not only the last stage.

In contrast, due to the gap inherent in tangential entry dovetail designs, a bucket cover, such as chain link bucket cover 42, cannot be continuously coupled to a complete row tangential-entry of buckets 16 and at the same time continuously circumscribe rotor wheel 14. The axial entry dovetail 22 of the exemplary embodiment is more efficient than tangential entry dovetail designs because a complete row of tangential entry buckets 16 is installed about rotor wheel 14 without a gap. This geometry enables bucket cover 42 to be coupled to each bucket tip 34 in a complete row of buckets 16 while continuously circumscribing rotor wheel 14. As a result, the complete row of axial entry dovetails 22 yields less unbalance.

In each embodiment, the above-described combination of axial entry dovetail bucket 16 and chain link bucket cover 42 facilitates increasing the tolerable loads of buckets 16. More specifically, in each embodiment, the combination of axial entry dovetail bucket 16 and chain link bucket cover 42 results in a significant increase in bucket 16 natural frequencies, fewer modes of bucket 16 vibration and increased overall mechanical reliability. Furthermore, each embodiment eliminates cover lock-up at off design speeds. As a result, turbine operation with higher output is facilitated. Accordingly, steam turbine performance and component useful life are each facilitated to be enhanced in a cost effective and reliable means.

Exemplary embodiments of axial entry dovetail buckets and bucket covers are described above in detail. The axial entry dovetail buckets and bucket covers are not limited to use with the specific steam turbine embodiments described herein, but rather, the axial entry dovetail and buckets can be utilized independently and separately from other components described herein. For example, the axial entry dovetail with continuous chain link bucket cover may be used with any utility, industrial or mechanical drive steam turbine. Moreover, the invention is not limited to the embodiments of the axial entry dovetail and bucket cover described above in detail. Rather, other variations of axial entry dovetail and bucket cover embodiments may be utilized within the spirit and scope of the claims.

While the invention has been described in terms of various specific embodiments, those skilled in the art will recognize that the invention can be practiced with modification within the spirit and scope of the claims.

What is claimed is:

1. A method for assembling a turbine assembly, said method comprising:
providing at least two buckets that each include an axial entry dovetail, a tip and an airfoil extending therebetween;
coupling the at least two buckets to a rotor wheel by inserting the axial entry dovetail into at least one complementary-configured mating dovetail slot defined in the rotor wheel; and
coupling a bucket cover to the tips of the at least two buckets such that the bucket cover substantially circumscribes the rotor wheel in a continuous band.

2. A method in accordance with claim 1 wherein coupling a bucket cover to the tips of the at least two buckets further comprises coupling the bucket cover to the tips in an overlapping chain link orientation.

3. A method in accordance with claim 1 wherein providing at least two buckets further comprises providing at least two buckets having one of a straight entry dovetail, a slanted entry dovetail and a curved entry dovetail.

4. A method in accordance with claim 1 further comprising coupling a plurality of buckets to the rotor wheel to form a row of buckets that extends circumferentially about the rotor wheel.

5. A method in accordance with claim 1 wherein providing at least two buckets further comprises providing at least two buckets that each include at least one tenon formed at the tip of each bucket.

6. A method in accordance with claim 5 wherein coupling a bucket cover to the tips of the at least two buckets further comprises forming the bucket cover from a plurality of links, wherein each link includes a first end having at least one opening extending therethrough and a second end having at least one opening extending therethrough.

7. A method in accordance with claim 6 wherein coupling a bucket cover to the tips of at least two buckets further comprises:
inserting at least one tenon into the at least one opening defined in the first end of a first one of the plurality of links; and
inserting at least one tenon into the at least one opening defined in the second end of a second one of the plurality of links.

8. A turbine assembly, said assembly comprising:
a rotor wheel comprising at least one dovetail slot defined therein;
at least two buckets that each comprise an axial-entry dovetail, a tip and an airfoil extending therebetween, each of said at least two buckets coupled to said rotor wheel via said dovetail slot; and
a bucket cover, said bucket cover coupled to said tip of said at least two buckets such that said bucket cover substantially circumscribes said rotor wheel.

9. An assembly in accordance with claim 8 wherein said bucket cover is coupled to said tip of said at least two buckets in an overlapping chain link orientation.

10. An assembly in accordance with claim 8 wherein said at least two buckets have one of a straight entry dovetail, a slanted entry dovetail and a slanted entry dovetail.

11. An assembly in accordance with claim 8 wherein a plurality of buckets are coupled to said rotor wheel to form a row of buckets that extends circumferentially about said rotor wheel.

12. An assembly in accordance with claim 8 wherein said at least two buckets further comprise at least one tenon formed at said tip of each bucket.

13. An assembly in accordance with claim 12 wherein said bucket cover comprises a plurality of links, wherein each link includes a first end having at least one opening extending therethrough and a second end having at least one opening extending therethrough.

14. An assembly in accordance with claim 13 further comprising:
said at least one tenon positioned within said at least one opening defined in said first end of a first one of said plurality of links; and
said at least one tenon being positioned within said at least one opening defined in said second end of a second one of said plurality of links.

15. A steam turbine assembly, said assembly comprising:
a rotor wheel comprising at least one dovetail slot defined therein;
at least two buckets each comprising an axial entry dovetail, a tip and an airfoil extending therebetween, each of said at least two buckets coupled to said rotor wheel, said dovetail being at least one of a straight entry dovetail, a slanted entry dovetail and a slanted entry dovetail; and
a bucket cover, said bucket cover coupled to said tip of said at least two buckets such that said bucket cover substantially circumscribes said rotor wheel and increases the natural frequency of said at least two buckets.

16. An assembly in accordance with claim 15 wherein said bucket cover is coupled to said tip of said at least two buckets in an overlapping chain link orientation.

17. An assembly in accordance with claim 15 wherein a plurality of buckets are coupled to said rotor wheel to form a row of buckets that extends circumferentially about said rotor wheel.

18. An assembly in accordance with claim 15 wherein said at least two buckets further comprise at least one tenon formed at said tip of each bucket.

19. An assembly in accordance with claim 18 wherein said bucket cover comprises a plurality of links, wherein each link includes a first end having at least one opening extending therethrough and a second end having at least one opening extending therethrough.

20. An assembly in accordance with claim 19 further comprising:
said at least one tenon positioned within said at least one opening defined in said first end of a first one of said plurality of links; and
said at least one tenon being positioned within said at least one opening defined in said second end of a second one of said plurality of links.
